(19) United States
(12) Patent Application Publication
(10) Pub. No.: US 2023/0021216 A1
(43) Pub. Date: Jan. 19, 2023

(54) SYSTEMS AND METHODS FOR DEPLOYING SECURE EDGE PLATFORMS

(71) Applicant: ManTech International Corporation, Herndon, VA (US)

(72) Inventors: Sandeep SHILAWAT, Herndon, VA (US); Srini IYER, Herndon, VA (US)

(73) Assignee: ManTech International Corporation, Herndon, VA (US)

(21) Appl. No.: 17/810,362

(22) Filed: Jul. 1, 2022

Related U.S. Application Data
(60) Provisional application No. 63/203,113, filed on Jul. 9, 2021.

(51) Int. Cl. H04L 41/12; H04L 67/10; H04L 41/16; H04L 9/40

(52) U.S. Cl. CPC H04L 41/12; H04L 67/10; H04L 41/16; H04L 63/1433

(57) ABSTRACT

System and methods for communication in a disconnected, intermittent, and limited (DIL) environment are disclosed and include receiving first data generated in the DIL environment at a cloud-in-a-box (CIB) appliance, processing the first data at the CIB appliance, determining that additional processing of the first data is required based on processing the first data at the CIB appliance, assigning a first priority level to the first data in response to determining that additional processing is required, wherein the first priority level is based on at least one of a user input, a predetermined criteria, or a prioritization machine learning model output, establishing a connection with a local area cloud component within the DIL environment, and transmitting a request for additional processing of the first data based on the first priority level.

### CROSS-REFERENCE TO RELATED APPLICATIONS

This application claims priority to U.S. Provisional Application No. 63/203,113 filed Jul. 9, 2021, the entire disclosure of which is hereby incorporated herein by reference in its entirety.

### TECHNICAL FIELD

Various embodiments of the present disclosure relate generally to secure edge platform environment and more particularly, to systems and methods for providing IaaS, PaaS, and an open zero trust architecture at edge environments.

### BACKGROUND

Entities operating in edge environments (e.g., in remote locations, locations with communication bubbles, military installations, etc.) lack modern computing capabilities. For example, such edge environments are often disconnected, intermittent, limited (DIL) environments that can be contested spaces where communications are challenged. A DIL environment can be caused by electronic warfare attacks and pose a serious threat to expeditionary or early entry operations that do not have the support of high capability systems. The use of modern computing capabilities is limited in these environments due to connectivity, support, and infrastructure issues.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating and displaying contextualized data.

In one aspect, an exemplary embodiment of a method for communication in a disconnected, intermittent, and limited (DIL) environment may include: receiving first data generated in the DIL environment at a cloud-in-a-box (CIB) appliance; processing the first data at the CIB appliance; determining that additional processing of the first data is required based on processing the first data at the CIB appliance; assigning a first priority level to the first data in response to determining that additional processing is required, wherein the first priority level is based on at least one of a user input, a predetermined criteria, or a prioritization machine learning model output; establishing a connection with a local area cloud component within the DIL environment; and transmitting a request for additional processing of the first data based on the first priority level.

In another aspect, an exemplary embodiment of a system for generating secure targeted outputs using a trained machine learning model may include: at least one memory storing instructions; and at least one processor executing the instructions to perform a process, the processor configured to: receive first data generated in a disconnected, intermittent, and limited (DIL) environment at a cloud-in-a-box (CIB) appliance; process the first data at the CIB appliance; determining that additional processing of the first data is required based on processing the first data at the CIB appliance; assign a first priority level to the first data in response to determining that additional processing is required, wherein the first priority level is based on at least one of a user input, a predetermined criteria, or a prioritization machine learning model output; establish a connection with a local area cloud component within the DIL environment; and transmit a request for additional processing of the first data based on the first priority level.

In another aspect, an exemplary embodiment of one or more non-transitory machine-readable media storing instructions that, when executed by one or more processors, cause performance of operations for generating communications in a disconnected, intermittent, and limited (DIL) environment may include: receiving first data generated in a DIL environment at a cloud-in-a-box (CIB) appliance; processing the first data at the CIB appliance; determining that additional processing of the first data is required based on processing the first data at the CIB appliance; assigning a first priority level to the first data in response to determining that additional processing is required, wherein the first priority level is based on at least one of a user input, a pre-determined criteria, or a prioritization machine learning model output; establishing a connection with a local area cloud component within the DIL environment; and transmitting a request for additional processing of the first data based on the first priority level.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts a chart that distinguishes levels of control in various environments, according to one or more embodiments.

FIG. 1B depicts an exemplary environment for patching software, according to one or more embodiments.

FIG. 1C depicts an exemplary environment for continuous integration and/or continuous delivery in a distributed environment, according to one or more embodiments.

FIG. 1D depicts an exemplary environment for generating cloud elasticity and infrastructure agility, according to one or more embodiments.

FIG. 2 depicts an exemplary system implementation of a cloud-in-a-box appliance, according to one or more embodiments.

FIG. 3 depicts an exemplary layer-level implementation of the cloud-in-a-box appliance, according to one or more embodiments.

FIG. 4A depicts an exemplary implementation of the cloud-in-a-box appliance, according to one or more embodiments.

FIG. 4B depicts an example implementation of the relationship between cloud computing, FOG computing, and MIST computing, according to one or more embodiments.

FIG. 5 depicts an exemplary environment for multiple cloud-in-a-box appliances operating in a cloud vendor agnostic system.

FIG. 6A depicts a flowchart of an exemplary method for communication in a DIL environment, according to one or more embodiments

FIG. 6B depicts a flowchart of an exemplary method for prioritization of data based on assigned priority levels, according to one or more embodiments

FIG. 7 depicts an example of training a machine learning model, according to one or more embodiments.

FIG. 8 depicts an example of a computing device, according to one or more embodiments.

### DETAILED DESCRIPTION OF EMBODIMENTS

Generally, communications within disconnected, intermittent, limited (DIL) environments may be inconsistent, challenged, and/or nonexistent, e.g., due to the low level of advanced technology and/or communication capabilities in the environment. Accordingly, improvements in technology relating to communications in edge environments are needed.

Use of commercial technologies (e.g., computing hardware, software, cloud technology, off the shelf technology, etc.) is limited in edge environments. Such use is limited, in part, because edge environments are often DIL environments. Accordingly, custom hardware and software suited for DIL environments is used and is often not updated due to the custom nature of the technology. As a result, over time, the custom hardware and software, and subsequent updates have lagged significantly behind technological advances found in commercial technologies.

Tactical environments have evolved to efficiently support ongoing counter-insurgent and expeditionary combat support operations. They were designed for hierarchical/pre-defined data flows that lack needed agility for the battlefield. Such environments were optimized for current mission sets without being based on well-defined systems and databases. Traditional tactical environments have not been able to exploit the benefits of modern technologies that allow easy interoperability because these features typically require a high availability link to the internet. This poses a significant challenge for warfighters at the tactical edge who are often faced with having to operate with scarce resources in a DIL environment.

Compounding this challenge can be the need to put large numbers of technical experts through a very time-intensive design/deployment period to get forward systems fully ready for combat operations. Traditional tactical environments are not well suited to overwhelm the decision cycle of near-peer adversaries. Having readily available capabilities that include elastic computation, advanced analytics, and artificial intelligence (AI)/machine learning (ML), as disclosed herein, will provide tremendous value to warfighters at the edge.

Defending enterprise networks at the core can be a challenge. With advances in active monitoring, data analytics, network operations center/security operations center (NOC/SOC) technologies, and security information and event management (SIEM), robust active defense mechanisms may be provided to protect core enterprises. However, defending the tactical edge presents additional challenges. For example, warfighters often operate in denied DIL environments and hostile areas where concealing an identity and operating in stealth mode is preferred. Currently, simple and secure techniques of connectivity to accomplish a given mission are limited (e.g., limited to outdated non-commercial technologies). Such limited techniques create a security and cost concern and lead to unavailability of decision support systems/services (DSS).

Implementations of the disclosed subject matter provide autonomous cyber defense capabilities deployed at the tactical edge. The cloud-in-a-box (CIB) platform discussed herein offers a high-bandwidth-capable, rugged, secure, and scalable solution capable of performing real-time data analytics in a DIL environment. The platform provides the ability to containerize the dependencies for applications that remain stovepiped while simultaneously providing capabilities that fully exploit all the advantages of cloud-based technology. Based on an open-architecture approach that leverages the benefits of micro-services, implementations provided herein are a shift from legacy offerings that are only able to tackle predefined and static requirements. The cloud-in-a-box platform adapts a zero trust model (ZTM) that provides security professionals the ability to make a given network electronically invisible, granting visibility and access only to those applications and services that fit user needs.

Implementations disclosed herein provide a hyper-converged implementation for use at the tactical edge. The implementations provide a scalable “cloud-in-a-box” capability that is physically hardened and provides a large amount of computational power in a small, dense, and rugged form factor. The implementations provide for disconnected operations as infrastructure-as-a-service (IaaS) to compute, network, and store applicable data. The implementations further provide a vendor agnostic platform-as-a-service (PaaS), using a container-based micro-services architecture with orchestration. These capabilities allow for the ingestion, storage, processing, and visualization of multiple petabytes of cyber data to perform real-time data analytics at the edge.

To secure devices and support components (e.g., warfighters) at the edge, commercial-off-the-shelf (COTS) products may be leveraged to provide a comprehensive and centralized approach to secure access control. Real-time access on a need-to-know basis may be provided for a unified way to control access while maintaining a high-security profile. For example, authentication may be required to access a resource. All authorized resources may be readily available to a given component (e.g., a warfighter), while all unauthorized resources may be electronically invisible. Such an implementation may clear out the clutter to the trusted edge users while masking capabilities to untrusted users (e.g., those with malicious intent). Accordingly, the zero trust capabilities disclosed herein ensure that that once proper access criteria is met, a dynamic one-on-one connection is generated from the given component (e.g., warfighter) device to the specific resource needed.

According to implementations disclose herein, autonomous corrective actions in networks and hosts may be supported. Leading capabilities to provide superior alerting and reporting, resulting in exceptional automated remediation actions may be provided. For example, upon detecting an anomaly, the IaaS and PaaS infrastructure may be utilized rapidly and reliably solve misconfiguration or infection, which is vital to success on the tactical edge.

Vulnerability scanners may be used to remediate compromised or misconfigured hosts through automated patch distribution or security technical implementation guide (STIG) remediation. Secure industry standard templates (e.g., such as national institutes of standards and technology (NIST) SP 800-53 rev. 4) may be adapted to maintain secure configurations of hosts and network devices, preventing unapproved modifications and reverting any misconfiguration or unauthorized changes to a known good state.

In addition, using COTS tools, a definitive record of activity and behavior across all tool categories may be provided in the operational environment. This may allow a security operations center (SOC) to identify trends and troubleshoot while performing root cause analysis that would be practically impossible to piece together from a conglomeration of individual tools.

The rapid sharing of intelligence may be facilitated across a given landscape to further respond at machine speed when misconfigurations are detected. The integrated capability may allow members of cyber protection teams to decipher alerts and share detected misconfigurations across the landscape instantly. Further, the integrated capability may automatically provision required security controls for the tactical community at machine speed.

Cyber security may be enhanced by sending all unknown executables suspected of malware to a sandbox for detonation to determine if the file acts as expected and/or take appropriate automated actions. The subsequent results may be used to update a malware engine, thereby making the sample known while associated signatures are distributed securely to other trusted users in the enterprise. A determination may be made whether the adversary has used encrypted communications to obfuscate their actions through covert channels.

In network segments, known vulnerabilities may automatically be blocked through the use of threat intelligence feeds. Endpoint vulnerability detection and mitigation may occur through the application of multiple autonomous safeguards including behavior analysis of control files, registry, and device access as well as through whitelisting and blacklisting of applications. Additionally, the blocking of zero-day exploits against vulnerabilities in popular software may be achieved through AI- and ML-enabled safeguards.

Security, orchestration, automation, and response (SOAR) implementations may improve by using “red teams” for the autonomous decision-making engines in existing SOAR platforms. The improvement may also be realized by utilizing real-world cyber scenarios executed in the safety of an advanced cyber range environment (ACRE). By creating representative environments in a closed range environment, in the cloud, on premise, or within a tactical cloud capability, ML models that elevate the state of current SOAR technologies may be trained. The training may be conducted from scripted and pre-determined playbook responses to adaptive responses based on real-time threats, delivering ML-informed recommendations to cyber operators.

The red teams may efficiently emulate the latest threats that are identified as malicious patterns or signatures and incorporate them into automated tools and methodologies. This technique may afford red teams and network defenders the ability to participate in full live-fire exercises where data can be corrupted, manipulated or destroyed with no concern that actual malware will get loose on an operational network.

According to implementations disclosed herein, cloud-in-a-box appliances may be used to perform Security information and email management (SIEM) and/or Security Orchestration, Automation and Response (SOAR) features. Such features may be performed using one or more containers within the cloud-in-a-box appliance.

Implementations disclosed herein provide a solution to the current technological limitations of technology used on edge platforms. As disclosed herein, a three tiered approach may be implemented using one or more cloud-in-a-box appliances and may include IaaS on the edge, PaaS on the edge, and/or a zero trust security architecture. The IaaS and PaaS may be vendor agnostic such that the cloud-in-a-box appliances can be utilized by any cloud vendor or software vendor. The zero trust security architecture may be an open architecture that allows for use of the three tiered approach with any applicable vendor. The cloud-in-a-box appliance may be 5G-enabled to utilize 5G bandwidth in edge environments that provide 5G connections.

The cloud-in-a-box appliance may be configured to provide availability, resiliency, elasticity based on the IaaS, PaaS, and zero trust architecture utilized therein. The cloud-in-a-box appliance may be configured for availability such that one or more backups are provided to mitigate the probability of downtime during use of the cloud-in-a-box appliance. The CIB appliance may maintain continuous availability by continuously scanning for one or more communication components, identifying a first communication component that meets a connectivity threshold based on scanning for the one or more communication components, and automatically connecting to the first communication component based on the identification. The requisite connectivity threshold may vary between CIB appliances, cloud components, other devices, and/or based on the data to be transmitted.

It may be resilient such that it is configured to tolerate faults (e.g., by implementing an alternative solution). The CIB appliance may tolerate faults by detecting a fault in the internal CIB appliance software and automatically implementing an alternative solution in response to detecting the fault. The cloud-in-a-box appliance may be configured for elasticity such that its capability may be adjusted based on need (e.g., additional capability when needed and reduce capability when needed).

As used herein, IaaS may include online services that provide high-level application programming interfaces (APIs) used to de-reference various low-level details of underlying network infrastructure like physical computing resources, location, data partitioning, scaling, security, backup, etc. For example, a cloud-in-a-box appliance may include a container provided as a PaaS (e.g., a Linux container, hypervisor such as Xen, Oracle VirtualBox, Oracle VM, KVM, VMware ESX/ESXi, Hyper-V, etc.) that runs one or more virtual machines (e.g., as a guest). Pools of containers within a cloud-in-a-box appliance-based operational system may support large numbers of virtual machines and the ability to scale services up and/or down according to varying requirements.

A cloud-in-the-box device IaaS solution may provision processing, storage, networks, and other fundamental computing resources that allow deployment and execution of software, which can include operating systems and applications. The solution may provide control over operating systems, storage, and deployed applications, as well as control of select networking components (e.g., host firewalls). As an example, the IaaS provided by the cloud-in-a-box appliance may enable image capturing via a hollow goggle lens, storage of the image via a backpack storage component, and analysis of the captured image via components of the backpack storage component.

A cloud-in-the-box device IaaS solution with PaaS may include the use of a cloud orchestration technology (e.g., OpenStack, Apache CloudStack or OpenNebula). Such technology may be used to manage creation of virtual machines (VMs), identify an applicable container (e.g., a host) to start VMs, enable VM migration features between hosts, allocate storage volumes and attach them to VMs, tracks usage information, and the like. A container may run in isolated partitions of a single kernel running directly on the physical hardware.

A cloud-in-the-box PaaS solution may also provide additional resources such as a virtual-machine disk-image library, raw block storage, file or object storage, firewalls, load balancers, internet protocol (IP) addresses, virtual local area networks (VLANs), software bundles, or the like.

A cloud-in-the-box device configured as a PaaS may manage and orchestrate containers, allow release of applications on the fly, allow patching applications on the fly, implement a zero trust architecture on the edge, and the like. A cloud-in-the-box device with PaaS may provide cloud computing services to provision, instantiate, run, and/or manage a modular bundle including a computing platform and one or more applications, without the complexity of building and maintaining the infrastructure typically associated with developing and launching the application(s). It may allow the creation, development, and packaging of such software bundles.

As used herein, a “cloud vendor” may be a cloud service provider (CSP) that enables an entity to create, host, launch, or otherwise activate one or more cloud accounts and provides cloud resources to use the one or more cloud accounts. Examples of cloud vendors include, but are not limited to Amazon Web Services® (AWS®), Google Cloud®, Microsoft Azure®, and the like. A cloud vendor may provide cloud services in addition to activating cloud accounts. The cloud services may allow an entity to manage user accounts within the cloud vendor's ecosystem. An entity using multiple cloud vendors may manage cloud accounts associated with a first cloud vendor via the first cloud vendor's management platform and may manage cloud accounts associated with a second cloud vendor via the second cloud vendor's management platform.

As used herein, a “software vendor” may be a vendor that integrates with a cloud vendor and provides a service to, or based on, the cloud vendor. Example software vendors may provide provisioning of auto-generated accounts (e.g., creating cloud accounts via a cloud vendor on an as needed basis), conducting compliance checks, implementing financial controls, managing digital workflows for enterprise operation, cloud management, cloud implementation, and/or the like. Software vendors may provide services to individual cloud vendors.

The cloud-in-a-box appliance may be a gateway to a cloud at the edge of a network such that it has limited network capability. The cloud-in-a-box appliance may be vendor agnostic (e.g., software vendor and cloud vendor agnostic). For example, the cloud-in-a-box appliance may connect to a first cloud vendor account and/or a second cloud vendor account. The cloud-in-a-box appliance may include scripts, codes, and/or architecture that enable it to interface with multiple different vendors either separately or at the same time.

Reference to any particular activity is provided in this disclosure only for convenience and not intended to limit the disclosure. The disclosure may be understood with reference to the following description and the appended drawings, wherein like elements are referred to with the same reference numerals. The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially”, “approximately”, or “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first user data could be termed a second user data, and, similarly, a second user data could be termed a first user data, without departing from the scope of the various described embodiments. The first contact and the second contact are both contacts, but they are not the same contact.

As used herein, the term “if” is, optionally, construed to mean “when” or “upon” or “in response to determining” or in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “vulnerability” or the like generally encompasses a flaw in the software that allows the system to perform unplanned actions. A vulnerability may be an exploitable condition within a software code that allows for attacks. As used herein, a “fault” or the like generally encompasses an error in software that may inhibit the software from performing its intended function. A fault may cause the software to act in an unanticipated manner.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data (e.g., historical user data, experiential data, and/or samples of input data), which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (“GBM”), deep learning, and/or a deep neural network. Supervised, semi-supervised, and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

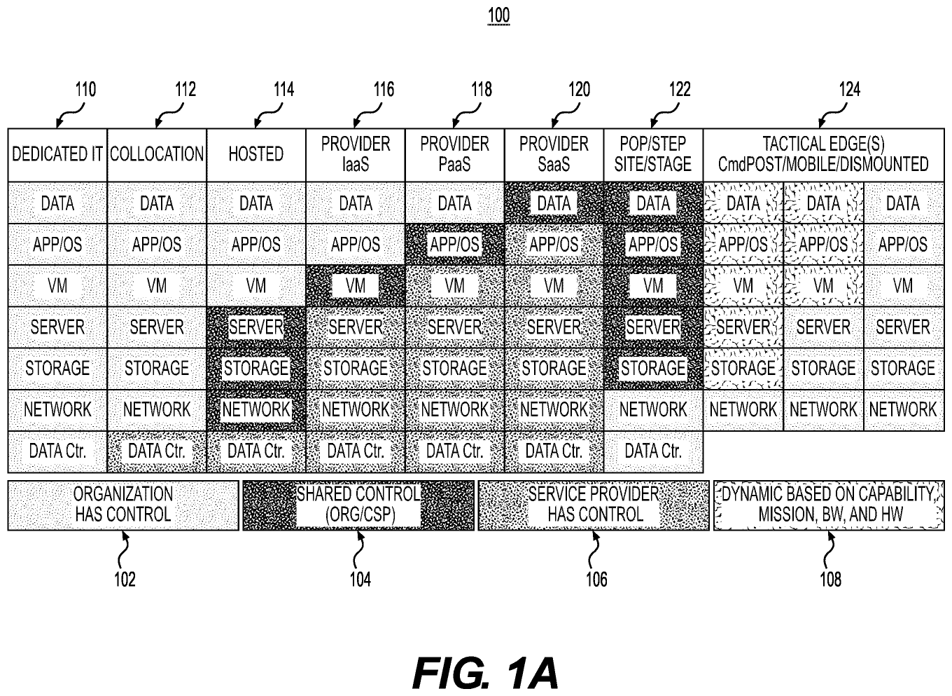

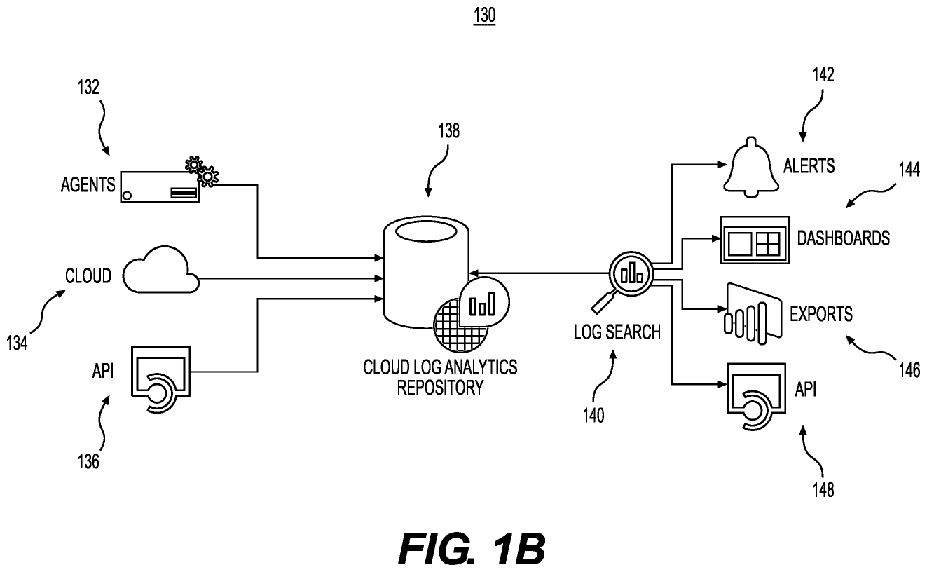

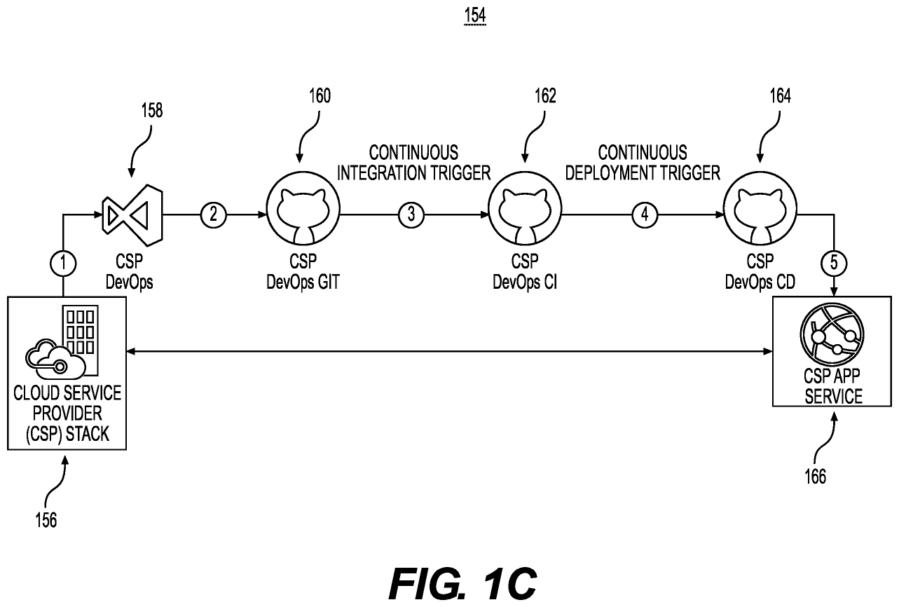

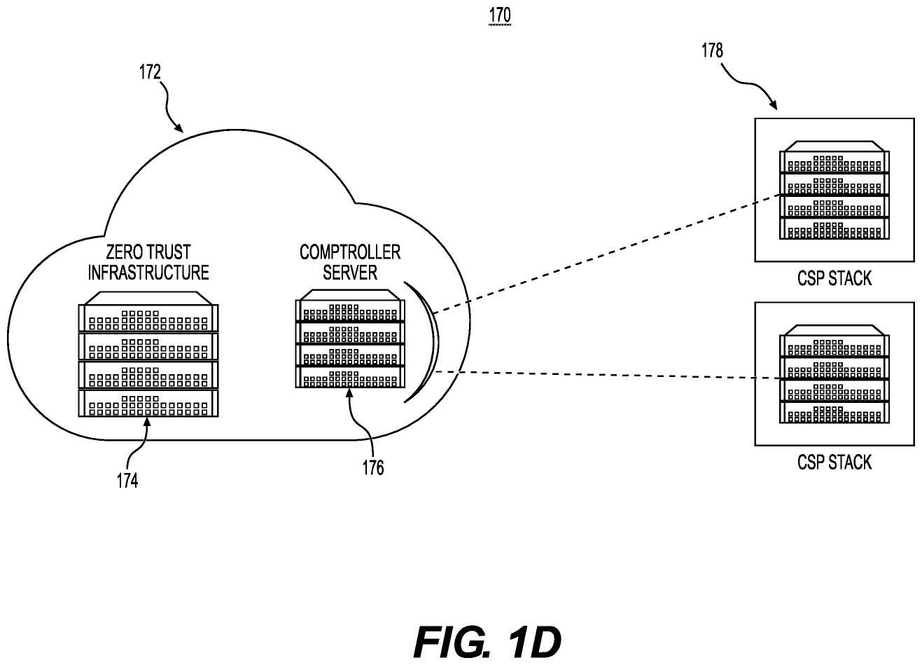

FIG. 1A shows a chart 100 that displays the differences in controlling parties and managed technology. The various controlling parties are implemented using organizational control 102, shared control 104 (e.g., organization/cloud service provider), cloud service provider control 106, and dynamic control based on capability, mission, bandwidth, and hardware (“dynamic control”) 108. The managed technology includes Dedicated IT 110, Collocation 112, Hosted Infrastructure 114, Provider IaaS (IaaS) 116, and Provider PaaS 118 (PaaS), Provider SaaS (Saas) 120, Point of Presence (POP) 122, and Tactical Edge 124. As shown in chart 100, the level of control generally shifts from organizational control 102 to service provider control 106 over a transition from Dedicated IT 110 to Provider PaaS 118. The control shown in the chart of FIG. 1A is for data, application/operating system, VMs, servers, storage, network, and data centers. For example, when using Provider PaaS, there is organizational control 102 over data, shared control 104 over application/operating system, and service provider control 106 over VMs, servers, storage, network, and data centers. The cloud-in-a-box appliance disclosed herein corresponds to the point of presence (POP) column 122 and the Tactical Edge 124 of FIG. 1A. As shown, the cloud-in-a-box appliance provides variability between organization control 102, shared control 104, service provider control 106, and dynamic control based on capability, mission, bandwidth, and hardware 108.

The cloud-in-a-box appliance may be wearable device (e.g., a watch, eyewear, backpack, etc.), a handheld device (e.g., a cell phone), or a non-wearable device (e.g., a laptop). For example, the cloud-in-a-box appliance may include a hollow lenses goggle configured for detection sensing. As another example, the cloud-in-a-box appliance may include a backpack that is configured to store an amount of data and interact with the hollow lens goggle. The hollow lens goggle may collect data via a camera and store the data at the backpack. As another example, the cloud-in-a-box appliance may include a service station in communication with the backpack for communicating the data to an external network. According to an implementation, the cloud-in-a-box appliance disclosed herein may be on a mobile component (e.g., a body, a non-motorized vehicle, a motorized vehicle, a boat, a plane, etc.). Two or more components of a cloud-in-a-box appliance (e.g., hollow lens glasses and backpack) may be connected to each other via a local network.

According to an implementation of the disclosed subject matter, a technology stack that allows a secure and efficient approach to IT modernization is provided. Products from technology leaders can be used with the implementations disclosed herein in conjunction with IT and applications. The cloud-in-a-box appliance and related technologies disclosed herein may allow expediting agency modernization efforts, while still keeping costs low and risk minimal.

CIB appliance software may be remotely patched, i.e. repaired. According to an implementation, the cloud-in-a-box appliance may be updated or patched without having to revise an entire code set that enables the cloud-in-a-box appliance to operate. CIB appliance software may scan for vulnerabilities and, if any vulnerabilities are detected, the CIB appliance software may identify the vulnerabilities. Identification of vulnerabilities may aid in determining what type of repairs are necessary, as well as determine the urgency of the repairs. The cloud-in-a-box appliance may be updated or patched by providing an updated container (e.g., of the plurality of containers that may be used to operate the cloud-in-a-box appliance). The updated container may be a code file that is downloaded over a short duration (e.g., less than one minute, less than one hour, etc.) connection between the cloud-in-a-box appliance and a cloud component. For example, an updated operating system container may replace an existing operating system container based on the cloud-in-a-box appliance connecting to a cloud server for four minutes. To repair the CIB appliance software, a repair process may be executed based on the updated container.

According to an implementation, remotely hosted infrastructure may be patched such that the patching is conducted remotely. FIG. 1B shows an example patching environment 130. One or more of an agent 132, a cloud 134, and/or an API 136 may determine that patching is required. The cloud log analytics repository 138 may allow the user to edit and run queries of data, such as patching. Patches may be found via a log search 140, which may provide an alert 142, a message to a dashboard 144, exportation of data 146, and/or a new and/or updated API 148.

The patches may be distributed to virtual machines on remote stack devices. By implementing remote patching, significant infrastructure efficiencies may be created. An automated dashboard may provide real-time status updates on compliance levels with different compliance policy standards. Patches may be applied to a cloud-in-a-box appliance or related component using organization change management processes that may be implemented using change management.

According to an implementation, one or more operation parameters at the CIB device may be modified in response to one of a user input, a predetermined data, or a parameter machine learning model output. For example, the CIB device may receive a parameter machine learning model output that shows a performance issue in the CIB device software or some other problem with the CIB device software. In response, the CIB device may modify the software's operating parameters to operate around the problem.

According to an implementation, continuous integration and/or continuous delivery may be implemented for the cloud-in-a-box appliance solution. As shown in flow diagram 154 of FIG. 1C, upgrades to software may be conducted seamlessly for cloud-in-a-box appliance and related solutions. The cloud-in-a-box appliance may be configured for plug and play of different local toolsets, which may allow existing administrators and release engineers to reuse appliance and/or related solutions without additional training. Flow diagram 154 of FIG. 1C provides an automation of a pipeline in a distributed environment. In an embodiment utilizing Microsoft Azure for cloud computing, the CSP Stack 156 may communicate with CSP DevOps 158 to obtain version control, reporting, requirements management, project management, automated builds, testing and release management capabilities. CSP DevOps 158 may communicate with CSP DevOps GIT 160 to track changes to any set of files. CSP DevOps GIT 160 may communicate with CSP DevOps CI 162 to utilize a continuous integration trigger. CSP DevOps CI 162 may communicate with CSP DevOps CD 164 to utilize continuous deployment. Both continuous integration and continuous deployment are used to construct build-deploy-test workflows. CSP DevOps CD 164 may communicate with CSP App Service 166. CSP App Service 166 may be utilized to quickly create cloud applications. CSP Stack 156 and CSP App Service 166 may communicate directly.

According to an implementation of the disclosed subject matter, a cloud-in-a-box appliance may connect to a cloud of its choice or may elect to remain dark by not connecting to any cloud. According to an implementation, a cloud-in-a-box appliance may connect to multiple clouds. For example, an agency may suffer from temporary workload increase or may have a need to move workload away from the agency due to, for example, business continuity or disaster recovery. The cloud-in-a-box appliance and related solutions may provide elasticity of the cloud for more agility of an infrastructure, as shown in diagram 170 of FIG. 1D. The elasticity infrastructure 172 may comprise the Zero Trust Infrastructure 174 and the Comptroller Server 176, which may allow elasticity infrastructure 172 to communicate with one or more CSP Stacks 178. The cloud-in-a-box appliance may access a given cloud service seamlessly, without any additional capacity planning services. The capacity of a given cloud-in-a-box appliance or related solution may be automatically monitored such that upon detection of a need for additional resources, a cloud platform connection may be established automatically.

According to an implementation, continuous security and continuous compliance may be provided via a cloud-in-a-box appliance and related solutions. The cloud-in-a-box appliance environment may strictly adhere to security controls and empirically prove compliance with controls such as National Institute of Standards and Technology's (NIST) risk management framework (RMF). A real-time dashboard may provide continuous compliance with requested security standards of organizational policy. The ability to implement tight security tests and controls may enable implementation of NIST's cybersecurity framework, as shown in diagram 170 of FIG. 1D, in real time (e.g., identify, protect, detect, respond, and recover).

According to an implementation, software training for cloud-in-a-box appliance may be implemented by creating a local training environment. For example, a mobile and/or virtual training environment may be provided using a cloud-in-a-box appliance based on the software as a service and IaaS capability of the cloud-in-a-box appliance. A software training environment may be coded at a first location and may be downloaded by the cloud-in-a-box appliance at a second location.

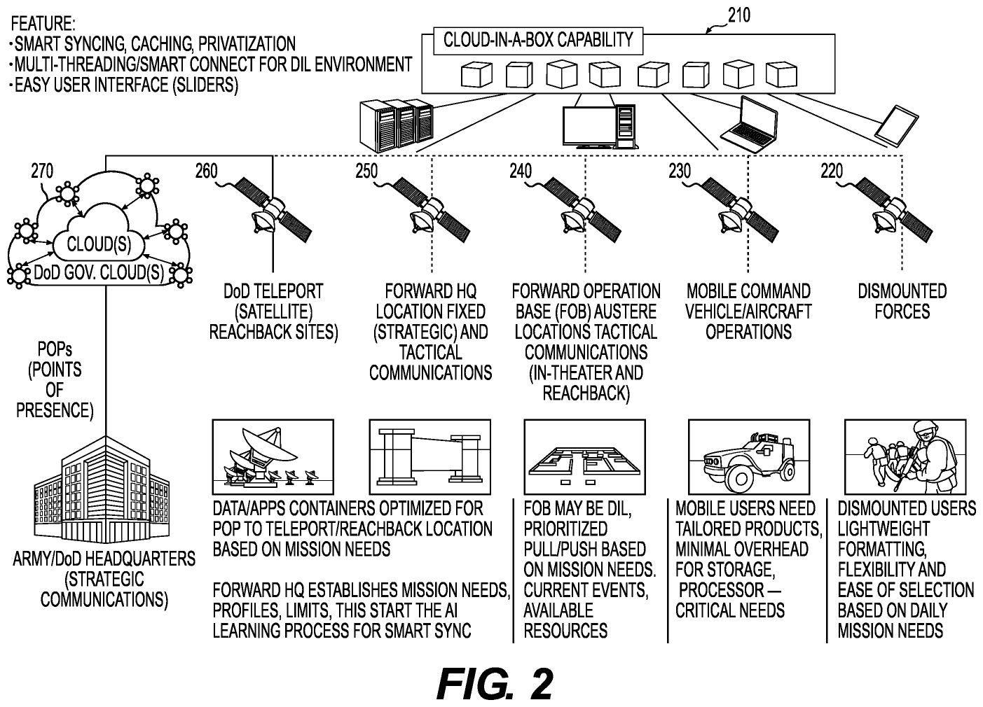

FIG. 2 shows an example system implementation of the disclosed subject matter. As shown in FIG. 2, a cloud-in-a-box appliance capability 210 can be implemented at a dismounted forces 220 level (e.g., to be used by a dismounted user as a wearable, or carried by a user and may include lightweight formatting, flexibility and ease of selection based on daily mission needs, etc.), mobile command vehicle/aircraft 230 level (e.g., a laptop, tablet, or other mobile device for mobile uses and having minimal overhead for storage, processor and other critical needs), a forward operation base 240 level (e.g., DIL/in-theater environments providing pull/push capability), forward headquarters 250 level (e.g., for strategic communications), and/or satellite 260 level (e.g., satellite reach back sites). The headquarters 250 level and satellite 260 level may facilitate data or application containers optimized for point of presence (POP) 122 to reach locations based on mission needs. A forward headquarter may establish mission needs, profiles, limits, one or more of which may initiate an AI learning process (e.g., a smart sync process between one or more components). One or more of the cloud-in-a-box appliance capability 210 may be in communication (e.g., direct, indirect, staggered, etc.) with clouds 270 that are connected to a base headquarter (e.g., with dedicated network connections). The cloud-in-a-box appliance capability 210 may provide smart syncing, caching, privatization, multi-threading/smart connect for DIL environments, and/or easy user interfaces (e.g., sliders).

Implementations disclosed herein, including diagrams of FIGS. 1A, 1B, 1C, and 1D and the example system implementation of FIG. 2, may provide a vendor-neutral cloud-in-a-box appliance built on open architecture standards configured to operate in DIL environments with an ability to sync back with a cloud component. The implementations may provide scalable cloud compute and storage capability for high-bandwidth applications/tool/technologies in such DIL environments. Scaling the CIB appliance may be based on available hardware. CIB appliance scaling may be accomplished by determining one or more capabilities required for a particular communication and modifying one or more CIB appliance capabilities to satisfy the one or more capabilities required for the particular communication. Scalability may be customizable to various CIB appliances and other hardware. For example, the cloud-in-a-box appliance may operate in disconnected environments, may support multiple vendor VMs, support containers with Kubernetes Orchestration, may support multiple container images, may isolate applications, and/or may sync with cloud components. The cloud-in-a-box appliance may facilitate federated decision making resulting in saved time, rapid deployment to improve time to mission, use of commercial grade technology for a strategic advantage, plug-and-play architecture and services for secured supply chains, open source and open architecture for reduction in funding, and a reduction in digital exhaust to reduce bandwidth and enhance operations in DIL environments.

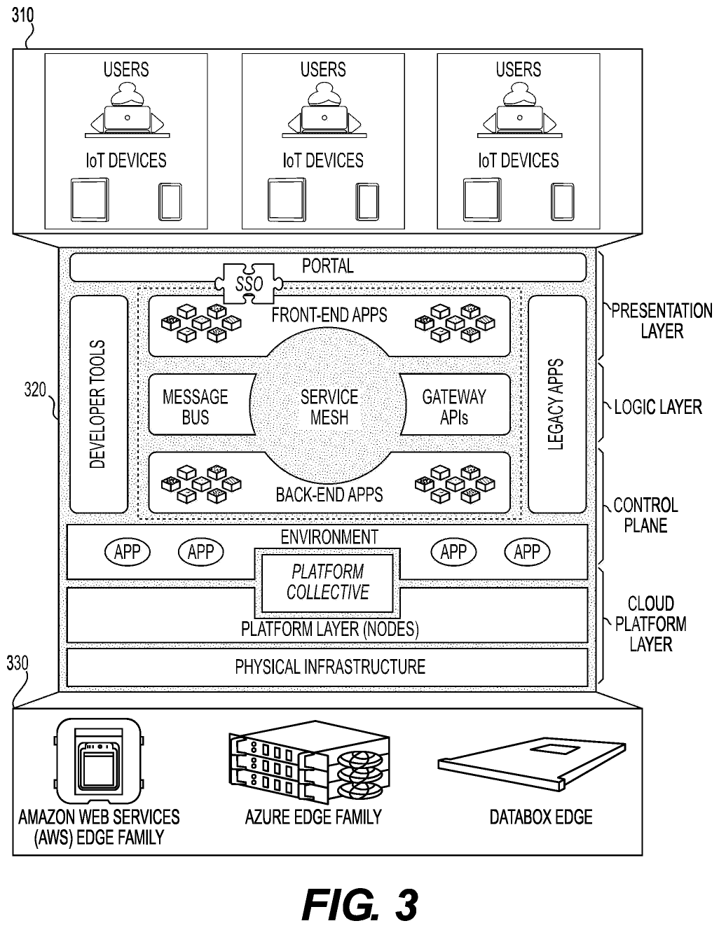

FIG. 3 shows a layer level overview of an implementation of the disclosed subject matter. As shown in FIG. 3, a user and device layer 310 may be in communication with a cloud-in-a-box appliance layer 320. The cloud-in-a-box appliance layer 320 may include a portal, an environment connected to a platform layer (e.g., nodes) via a platform collective, and physical infrastructure. The portal may include developer tools, legacy applications, as well as a service mesh that includes front end applications, message busses, gateway APIs, and/or backend applications. The cloud-in-a-box appliance layer 320 may be segmented into a presentation layer, a logic layer, a control plane, and a cloud platform layer. The cloud-in-a-box appliance layer 320 may be in communication with one or more edge devices 330 such as an AWS Edge Family, an Azure Edge Family, a DataBox edge, or the like.

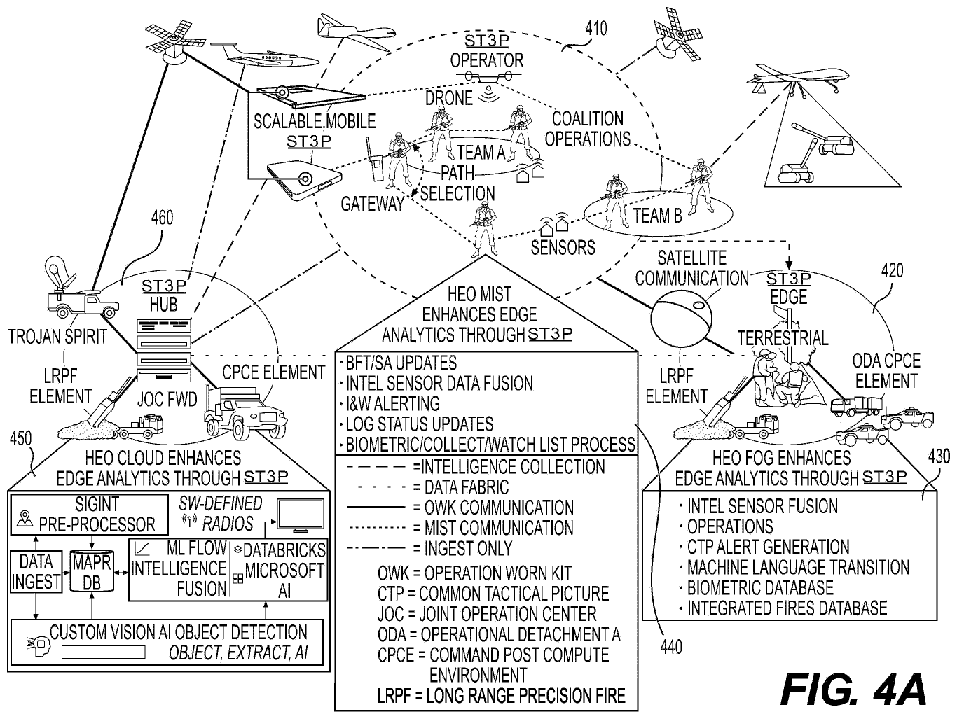

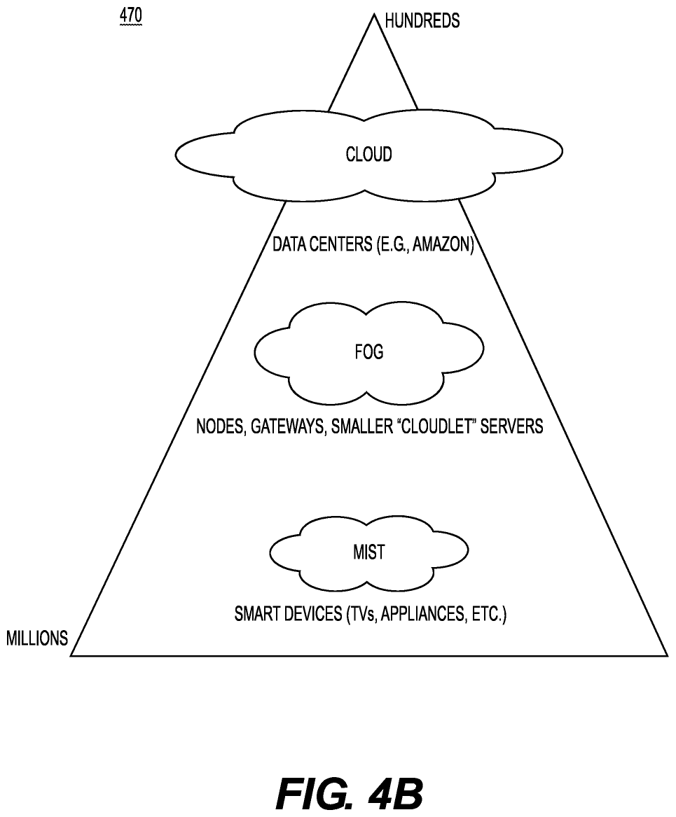

FIG. 4A shows provides an example implementation of the cloud-in-a-box appliance as discussed herein. The example cloud-in-a-box-based system may include an operator component 410, an edge component 420, a Hyper Enabled Operator (HEO) FOG computing edge analytics component 430, a HEO MIST computing edge analytics component 440, a HEO cloud edge analytics component 450, and a HUB component 460. FIG. 4B shows an example environment 470 of the relationship between cloud computing, FOG computing, and MIST computing. FOG computing decentralizes applications, management and data analytics into the network itself, minimizing the time between requests and responses by providing both local computing resources for devices and network connectivity to centralized services. MIST computing may be defined as a “lightweight” or sub-fog layer that resides in the network fabric, with its nodes placed closer to edge devices. It may include microcomputers and microcontrollers to feed data into FOG computing nodes and potentially into centralized computing services.

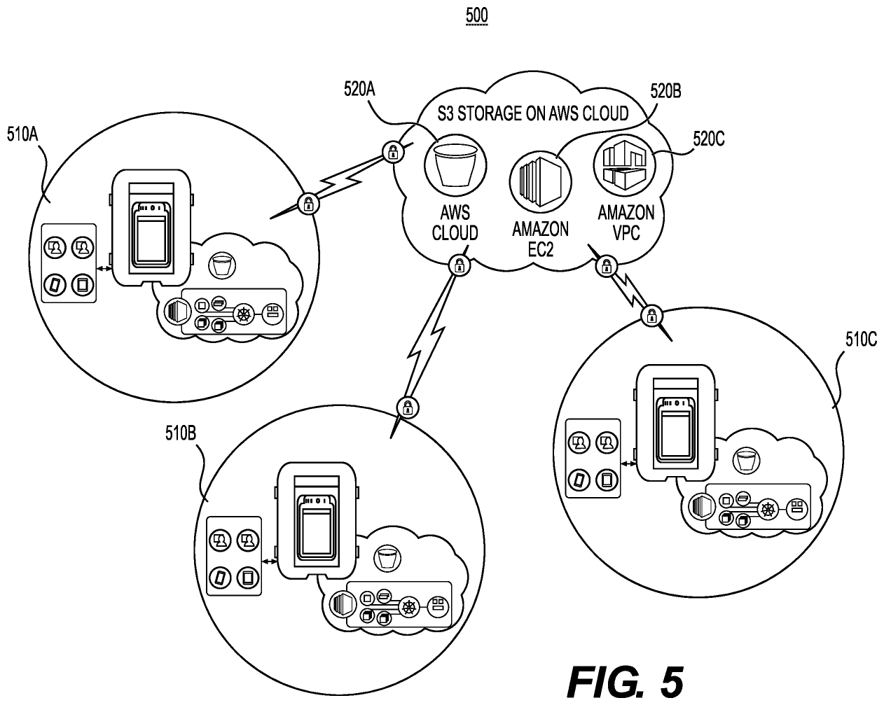

FIG. 5 shows an example multiple cloud-in-a-box appliances 510A, 510B, and 510C operating in a cloud vendor agnostic system. As shown, one or more of the multiple cloud-in-a-box appliances 510A, 510B, and 510C may securely connect to one or more cloud vendors 520A, 520B, and/or 520C or may connect to a cloud vendor without determining which cloud vendor of the multiple cloud vendors 520A, 520B, and/or 520C it connects to. Such agnostic operation may enable use of commercial technology as the commercial technology may not be vendor specific.

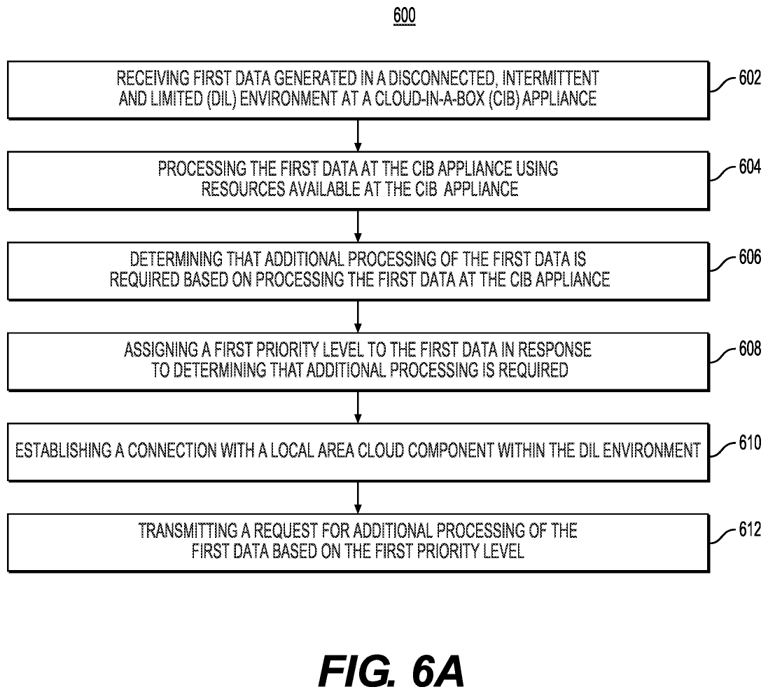

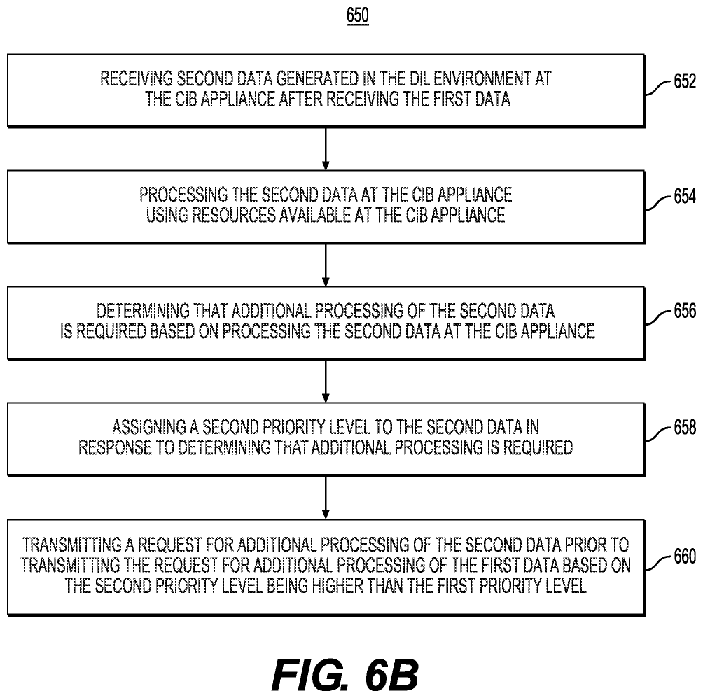

FIG. 6A illustrates an exemplary process 600 for communication in a DIL environment, according to one or more embodiments. Communication in the DIL environment may be based on communication capability, bandwidth availability, and hardware availability. Communication capability may be based on the physical distance between the CIB appliance and one or more other communication components within the DIL environment. For example, if the CIB appliance is 100 miles from the nearest communication component, the communication capability may be minimal. In another example, if the CIB appliance is within 10 miles of the nearest communication component, the communication capability may be available. The bandwidth availability may be based on the amount of data that can be transmitted within a given time period. A greater amount and/or size of data being transmitted may result in a lower the bandwidth availability and a lesser amount and/or size of data being transmitted may result in a higher bandwidth availability. Hardware availability may be based on what devices are available in the DIL environment and their respective capabilities.

At step 602, a CIB appliance may receive first data that was generated in the DIL environment. The first data may be in any form, such as pictures, text, videos, signals, etc. The data may be generated using one or more hardware or software components including, but not limited to the CIB appliance. The first data may be generated based on automated or user operation. For example, the first data may include capturing an image or video using a CIB appliance component or a component in communication with the CIB appliance. The first data may be generated in the DIL environment such that the first data may be generated without communication with a component outside the DIL environment (e.g., a cloud component).

At step 604, the CIB appliance may process the first data. The CIB appliance may process the data using any suitable means using resources available to the CIB appliance within the DIL environment. The CIB appliance may use a machine learning model to process the first data. Training the machine learning model is discussed in more detail below. The machine learning model may process the first data to determine whether the data contains any important and/or relevant information as determined by the interested parties. For example, the machine learning model may process a photograph to determine whether the photograph shows a given individual or item. Processing the first data at the CIB appliance may be limited to the capabilities of the CIB appliance (e.g., preloaded software, data, etc.) without having access to a non-DIL environment component.

At step 606, the CIB appliance may determine that additional processing of the first data is necessary. The CIB appliance may use any suitable data point or processing technique to determine if additional processing is necessary. In an example where the CIB appliance is processing a photograph, the CIB appliance may use a machine learning model to determine that the photograph may show high priority information, but may need further processing for accuracy.

A determination may be made that additional processing of the first data is necessary based on a threshold processing score. The determination may be made at the CIB appliance or a component associated with the CIB appliance within the DIL environment. The CIB appliance may be configured to determine a processing score for the first data, after processing the first data. The processing score may be based on completeness of the processing output, a quantity or quality of the output of the processing, and/or completeness of the steps undertaken to determine an output of the processing. The processing score may be compared to the threshold processing score. The threshold processing score may be pre-determined or may be output by a processing score machine learning model. The processing score machine learning model may receive the first data, the output of the processing, and/or the steps taken to determine the output. The processing score machine learning model may be trained to output a processing score based on one or more of the inputs. The processing score and/or the threshold processing score may be in any applicable format such as a percentage, a ratio, a number, a range, a tier, or the like. Accordingly, if the processing score does not meet or exceed the threshold processing score, then a determination may be made that additional processing of the first data is necessary. A determination that additional processing of the first data is necessary may be made such that the capabilities of the CIB appliance do not allow for the additional processing.

At step 608, the first data may be assigned a priority level if additional processing is determined necessary at step 606. The priority level may be based on at least one of a user input, a predetermined criteria, or a prioritization machine learning model output. For example, the machine learning model may determine that the first data has a high priority. According to an implementation, a user in the DIL environment may process the first data and approve the machine learning output. The user in the DIL environment may then approve the machine learning model's priority level, assign the high priority directly, or modify the priority level.

The priority level may be based on the type of first data captured, the content of the first data, the time of the first data being captured, the DIL environment, or the like. The priority level may be any applicable hierarchical level such as a ranking, a number, a tier, or the like. The priority level may be assigned relative to one or more processing levels assigned to one or more other data (e.g., a second data). Accordingly, the machine learning model may receive as inputs, or may have access to, one or more priority levels for one or more other data. The machine learning model may output a priority level based on those one or more priority levels for the one or more other data. Accordingly, the priority levels may rank all data marked for additional processing.

At step 610, a connection with a local area cloud component within the DIL environment may be established. The connection may be established by any suitable device, e.g., the CIB appliance. As discussed above, the CIB appliance may be vendor neutral as to cloud services. The connection may be established upon assigning the first priority level at 608 or may be established when access to the local area cloud component is established. For example, the local area cloud component may not be accessible to the CIB appliance when the first data is generated at 602, when the data is processed at 604, when determining that additional processing of the first data is required at 606, or when assigning a first priority level at 608. Rather, the local area could component may be accessible to the CIB appliance after one of the steps 602-608 such as after assigning the first priority level at 608. It will be understood that if the local area cloud component is available at one of the steps 602-608, then the first data may be automatically transmitted to the local area cloud component based on existing priority levels upon determination that additional processing of the data is required at 606, if no additional data is in queue for processing.

At step 612, a request for additional processing of the first data may be transmitted in accordance with the priority level assigned at 608, in view of additional data in queue for processing and the respective priority levels of the additional data. The request may be transmitted to any suitable entity (e.g., an entity in the DIL environment), such as the one or more entities shown in FIG. 2.

As discussed in step 608 above, the order the data may be sent may depend on its assigned priority level. The priority level may depend on the time the data is collected, the machine learning analysis, or on another suitable measure, as disclosed herein. FIG. 6B illustrates an exemplary process 650 for prioritization of data based on assigned priority levels, according to one or more embodiments. At step 652, first data may be received before second data. As discussed above, the first data and second data may be in any form, e.g., the first data may be a video and the second data may be a photograph. At step 654, the second data may be processed by the CIB appliance. As discussed above, the CIB appliance may utilize a machine learning model to analyze the second data. The machine learning model output for the second data may be used to determine the priority level of the second data. At step 656, the CIB appliance may determine that the second data requires further processing. As discussed above, the CIB appliance and/or a machine learning model may determine that further processing is required. The machine learning model may make this determination based on any suitable factors, such as accuracy, specificity, etc.

At step 658, the second data may be assigned a priority level with respect to the first data. The second priority level, i.e. the priority level assigned to the second data, may be higher than the first priority level, i.e. the priority level assigned to the first data. As discussed above, the second priority level may be based on at least one of a user input, a predetermined criteria, or a prioritization machine learning model output. The user may base the second data assigned priority level on the machine learning model output, the user's analysis of the second data, or any other suitable basis. As discussed above, the first data priority may be determined the same way or similarly. For example, the machine learning model may analyze both the first data and the second data, and suggest that the second priority level be higher than the first priority level. The user in the DIL may review the machine learning outputs for the first data and second data and confirm that the second priority level is higher than the first priority level based on any suitable reasoning, such as the second data having greater clarity than the first data. At step 660, a request for further processing of the second data may be transmitted prior to the request for further processing of the first data, where the second priority level is higher than the first priority level. The request for further processing of the second data may be chronologically transmitted to the request for further processing of the first data, based on the respective priority levels. According to this embodiment, higher priority analysis may be conducted prior to respective lower priority data. Accordingly, in a DIL environment where connectivity and/or connection times to a local component may be limited, higher priority data may be prioritized over respective lower priority data. In such an implementation, with limited connectivity or connection times, higher priority data may be further analyzed whereas lower priority data may not be analyzed at all or analyzed during a subsequent connection with the local component. As discussed above, the second data may be transmitted to one or more entities.

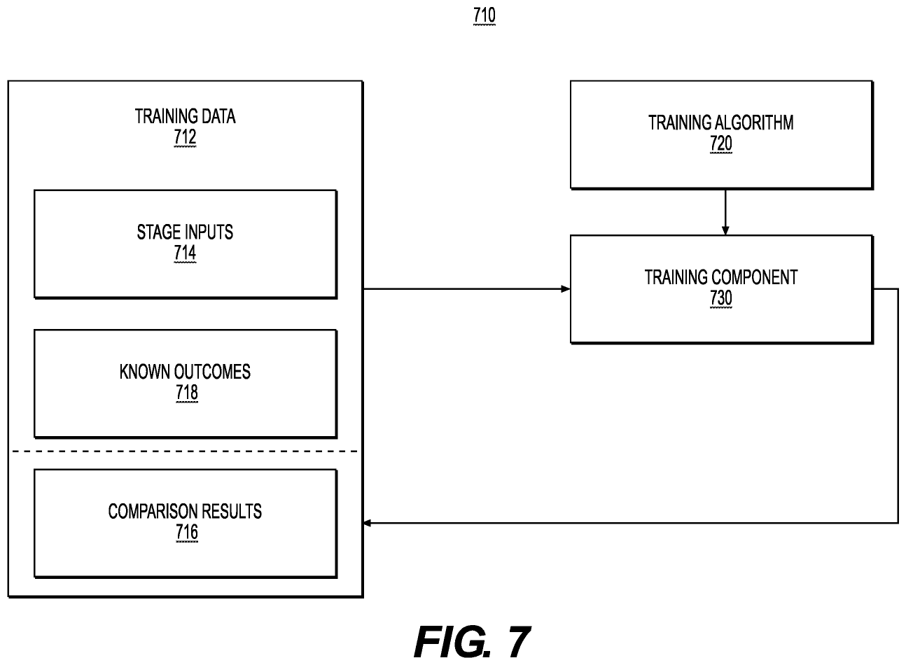

One or more components of the disclosed subject matter may be implemented using one or more machine learning models, as disclosed herein. A machine learning model may be used to fluctuate between dynamic control (e.g., organization control vs service provider control, as shown in FIG. 1A), may be used to determine connectivity preferences in a DIL environment, may be used to determine when and/or how to patch one or more containers, or the like. FIG. 7 depicts a flow diagram for training a machine learning model to implement a targeted medical outreach, according to one or more embodiments. One or more of training data 712, stage inputs 714, known outcomes 718, comparison results 716, a training algorithm 720, and a training component 730 may communicate by any suitable means. One or more implementations disclosed herein may be applied by using a machine learning model. A machine learning model as disclosed herein may be trained using chart 100 of FIG. 1A, environment 130 of FIG. 1B, flow diagram 154 of FIG. 1C, diagram 170 of FIG. 1D, environment 200 of FIG. 2, environment 300 of FIG. 3, environment 400 of FIG. 4A, environment 470 of FIG. 4B, and/or environment 500 of FIG. 5. As shown in flow diagram 710 of FIG. 7, training data 712 may include one or more of stage inputs 714 and known outcomes 718 related to a machine learning model to be trained. The stage inputs 714 may be from any applicable source including a component or set shown in FIGS. 1A, 1B, 1C, 1D, 2, 3, 4A, 4B, and/or 5. Known outcomes 718 may be included for machine learning models generated based on supervised or semi-supervised training. An unsupervised machine learning model might not be trained using known outcomes 718. Known outcomes 718 may include known or desired outputs for future inputs similar to or in the same category as stage inputs 714 that do not have corresponding known outputs.

Training data 712 and a training algorithm 720 may be provided to a training component 730 that may apply training data 712 to training algorithm 720 to generate a trained machine learning model. According to an implementation, training component 730 may be provided comparison results 716 that compare a previous output of the corresponding machine learning model to apply the previous result to re-train the machine learning model. Comparison results 716 may be used by training component 730 to update the corresponding machine learning model. Training algorithm 720 may utilize machine learning networks and/or models including, but not limited to a deep learning network such as Deep Neural Networks (“DNN”), Convolutional Neural Networks (“CNN”), Fully Convolutional Networks (“FCN”) and Recurrent Neural Networks (“RCN”), probabilistic models such as Bayesian Networks and Graphical Models, and/or discriminative models such as Decision Forests and maximum margin methods, or the like. The output of the flow diagram 710 may be a trained machine learning model.

It should be understood that embodiments in this disclosure are exemplary only, and that other embodiments may include various combinations of features from other embodiments, as well as additional or fewer features. For example, while some of the embodiments above pertain to implementing an automated outreach, any suitable activity may be used. In an exemplary embodiment, instead of or in addition to automated outreach to a patient, implementing a targeted medical outreach may include providing input to a medical provider's GUI.

In general, any process or operation discussed in this disclosure that is understood to be computer-implementable, such as the processes illustrated in FIGS. 1A, 1B, 1C, 1D, 2, 3, 4A, 4B, 5, 6A, 6B, and 7 may be performed by one or more processors of a computer system, such any of the systems or devices in the environment 200 of FIG. 2, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (“CPU”), a graphics processing unit (“GPU”), or any suitable types of processing unit.

A computer system, such as a system or device implementing a process or operation in the examples above, may include one or more computing devices, such as one or more of the systems or devices in FIG. 5. One or more processors of a computer system may be included in a single computing device or distributed among a plurality of computing devices. A memory of the computer system may include the respective memory of each computing device of the plurality of computing devices.

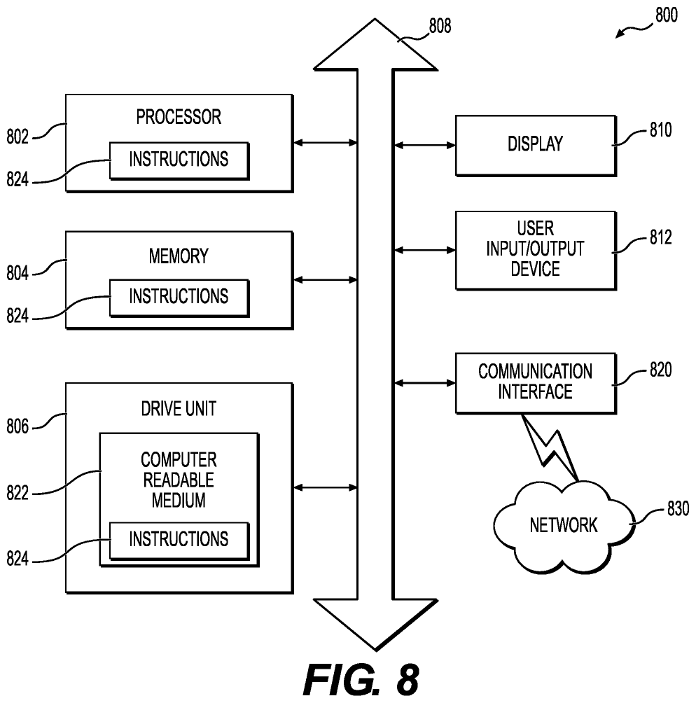

FIG. 8 is a simplified functional block diagram of a computer 800 that may be configured as a device for executing the method of FIGS. 6A and/or 6B, according to exemplary embodiments of the present disclosure. One or more of a processor 802, a memory 804, a drive unit 806, an internal communication bus 808, a display 810, a under input/output ports 812, a communication interface 820, a computer readable medium 822, instructions 824, and a network 830 may communicate by any suitable means. For example, computer 800 may be configured as a CIB appliance and/or another system according to exemplary embodiments of this disclosure. In various embodiments, any of the systems herein may be a computer 800 including, for example, data communication interface 820 for packet data communication. Computer 800 also may include a central processing unit (“CPU”) 802, in the form of one or more processors, for executing program instructions. Computer 800 may include internal communication bus 808, and storage unit 806 (such as Read-Only Memory (“ROM”), Hard Disk Drive (“HDD”), Solid-State Drive (“SSD”), etc.) that may store data on computer readable medium 822, although computer 800 may receive programming and data via network communications. Computer 800 may also have memory 804 (such as Random-Access Memory (“RAM”)) storing instructions 824 for executing techniques presented herein, although instructions 824 may be stored temporarily or permanently within other modules of computer 800 (e.g., processor 802 and/or computer readable medium 822). Computer 800 also may include input and output ports 812 and/or display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for communication in a disconnected, intermittent, and limited (DIL) environment, the method comprising:
receiving first data generated in the DIL environment at a cloud-in-a-box (CIB) appliance;
processing the first data at the CIB appliance;
determining that additional processing of the first data is required based on processing the first data at the CIB appliance;
assigning a first priority level to the first data in response to determining that additional processing is required, wherein the first priority level is based on at least one of a user input, a predetermined criteria, or a prioritization machine learning model output;
establishing a connection with a local area cloud component within the DIL environment; and
transmitting a request for additional processing of the first data based on the first priority level.

2. The method of claim 1, wherein the DIL environment is based on a DIL communication capability, a DIL bandwidth availability, and a DIL hardware availability.

3. The method of claim 2, wherein the DIL communication capability is based on a physical distance between the CIB appliance and one or more other communication components within the DIL environment.

4. The method of claim 1, further comprising:
requesting a cloud connection;
determining that the cloud connection is unavailable; and
assigning the first priority level to the first data further in response to determining that the cloud connection is unavailable.

5. The method of claim 1, wherein the CIB appliance comprises hardware, software, and open architecture software.

6. The method of claim 1, wherein the CIB appliance is one of a wearable device, a handheld device, or a non-wearable device.

7. The method of claim 1, further comprising remotely repairing internal CIB appliance software by:
scanning for vulnerabilities;
detecting a vulnerability in the internal CIB appliance software;
receiving an updated container at the CIB appliance, based on detecting the vulnerability in the internal CIB appliance software; and
executing a repair process based on the updated container to repair the internal CIB appliance software.

8. The method of claim 1, further comprising modifying one or more operation parameters at the CIB appliance, in response to one of the user input, the predetermined data, or the parameter machine learning model output.

9. The method of claim 1, wherein the CIB appliance is configured to maintain continuous availability by:
continuously scanning for one or more communication components;
identifying a first communication component that meets a connectivity threshold based on scanning for the one or more communication components; and
automatically connecting to the first communication component based on the identifying the first communication component.

10. The method of claim 1, wherein the CIB appliance is configured to maintain resiliency by:
detecting a fault in an internal CIB appliance software; and
automatically implementing an alternative solution, in response to detecting the fault.

11. The method of claim 1, further comprising scaling the CIB appliance based on available hardware by:
determining one or more capabilities required for a particular communication; and
modifying one or more CIB appliance capabilities to satisfy the one or more capabilities required for the particular communication.

12. The method of claim 1, wherein the predetermined criteria is based on historical data.

13. The method of claim 1, wherein the prioritization machine learning model is trained based on historical data prioritization.

14. The method of claim 1, wherein the connection is a 5G-enabled connection.

15. The method of claim 1, further comprising:
receiving second data generated in the DIL environment at the CIB appliance, after receiving the first data;
processing the second data at the CIB appliance;
determining that additional processing of the second data is required based on processing the second data at the CIB appliance;
assigning a second priority level to the second data in response to determining that additional processing is required, wherein the second priority level is a higher priority level than the first priority level; and
transmitting a request for additional processing of the second data prior to transmitting the request for additional processing of the first data based on the second priority level being higher than the first priority level.

16. The method of claim 15, wherein the second priority level is based on at least one of a second user input, the predetermined criteria, or the prioritization machine learning model output.

17. A system for generating secure targeted outputs using a trained machine learning model, the system comprising:
at least one memory storing instructions; and
at least one processor executing the instructions to perform a process, the processor configured to:
receive first data generated in a disconnected, intermittent, and limited (DIL) environment at a cloud-in-a-box (CIB) appliance;
process the first data at the CIB appliance;
determining that additional processing of the first data is required based on processing the first data at the CIB appliance;
assign a first priority level to the first data in response to determining that additional processing is required, wherein the first priority level is based on at least one of a user input, a predetermined criteria, or a prioritization machine learning model output;
establish a connection with a local area cloud component within the DIL environment; and
transmit a request for additional processing of the first data based on the first priority level.

18. The system of claim 17, wherein the processor is a central processing unit (CPU), a graphics processing unit (GPU), or any suitable type of processing unit.

19. One or more non-transitory machine-readable media storing instructions that, when executed by one or more processors, cause performance of operations for generating communications in a disconnected, intermittent, and limited (DIL) environment, the operations comprising:
receiving first data generated in a DIL environment at a cloud-in-a-box (CIB) appliance;
processing the first data at the CIB appliance;
determining that additional processing of the first data is required based on processing the first data at the CIB appliance;
assigning a first priority level to the first data in response to determining that additional processing is required, wherein the first priority level is based on at least one of a user input, a pre-determined criteria, or a prioritization machine learning model output;
establishing a connection with a local area cloud component within the DIL environment; and
transmitting a request for additional processing of the first data based on the first priority level.

20. The non-transitory machine-readable media of claim 19, wherein the connection is a 5G-enabled connection.
